(19) United States
(12) Patent Application Publication
(10) Pub. No.: US 2008/0211355 A1
(43) Pub. Date: Sep. 4, 2008

(54) STEPPING MOTOR

(76) Inventors: Takanori SAKAMOTO, Tokyo (JP); Yuki IMAMURA, Tokyo (JP)

Correspondence Address: WHITHAM, CURTIS & CHRISTOFFERSON & COOK, P.C., 11491 SUNSET HILLS ROAD, SUITE 340, RESTON, VA, 20190, US

(21) Appl. No.: 12/036,625

(22) Filed: Feb. 25, 2008

(30) Foreign Application Priority Data
Feb. 26, 2007 (JP) P.2007-046030

(51) Int. Cl. H02K 37/00

(52) U.S. Cl. 310/49 R

(57) ABSTRACT

A rotor rotable about a rotary axis is magnetized so as to have a plurality of poles along a circumferential direction thereof. Stator yokes each of which has a plurality of pole portions facing an outer circumferential face of the rotor is provided. An exciting coil is wound on the pole portions. Each of the stator yokes is made of a sheet of silicon steel having a thickness of 0.7 mm.

### BACKGROUND OF THE INVENTION

1. Field of the Invention

The present invention relates to a stepping motor, and more particularly to a stepping motor which can increase torque and decrease detent torque.

2. Description of the Related Art

For example, Japanese Patent Application No. 2005-110377A discloses a stepping motor which includes a rotor element made up of a permanent magnet which is magnetized to a multiplicity of poles, a stator yoke element provided in such a manner as to face the rotor element concentrically and having a plurality of comb tooth-like pole portions, exciting coils mounted on outer circumferential portions of the comb tooth-like pole portions and a case yoke element encompassing the exiting coils and the stator yoke element.

In addition, many of stator yokes of recent stepping motors are made by a pressed sheet of silicon steel and are manufactured using sheets of silicon steel which are normally 0.5 mm thick.

### SUMMARY OF THE INVENTION

Incidentally, on the current markets, in addition to the demand for smaller and inexpensive stepping motors, there is a demand for stepping motors which can provide a higher torque. In order to realize such stepping motors which can provide a higher torque, the amount of windings of exiting coils has to be increased, and the quality level of materials for permanent magnets has to be increased. However, in the event that the amount of windings of the exiting coils of a stepping motor is increased, the miniaturization of the stepping motor is interrupted, and in the event that the quality level of a material for a permanent magnet is increased, the production costs are increased considerably.

In addition, in recent years, in conjunction with emergence of demands for higher performances on various types of equipment, there has emerged a demand for stepping motors with a low detent torque. In the case of a stepping motor having a large detent torque, the torque ripple and revolution speed ripple of the motor are increased, producing drawbacks of vibration and noise. In addition, when the stepping motor is used as a positioning motor, the positioning accuracy is decreased.

An object of the invention is to provide a stepping motor, which is small in size and which can increase the torque and decrease the detent torque while maintaining the low production costs.

According to an aspect of the invention, there is provided a stepping motor including a cylindrical rotor rotable about a rotary axis, the rotor being magnetized so as to have a plurality of poles along a circumferential direction thereof, stator yokes each of which has a plurality of pole portions facing an outer circumferential face of the rotor, an exciting coil wound on the pole portions, and a case yoke accommodating the exciting coil and the stator yokes, wherein each of the stator yokes is made of a sheet of silicon steel having a thickness of 0.7 mm.

According to the configuration described above, by forming the stator yoke element of the sheet of silicon steel which is substantially 0.7 mm thick, the torque can be increased and the detent torque can be decreased compared to the conventional stepping motor in which the stator yoke element is formed of the sheet of silicone steel which is 0.5 mm thick.

In the stepping motor according to the aspect of the invention, since the stator yoke element is formed of the sheet of silicone steel which is substantially 0.7 mm thick, a reduction in size and an increase in torque can be attained without increasing the production costs. In addition, a reduction in detent torque can be attained, so as to reduce the vibration and noise of the motor.

### BRIEF DESCRIPTION OF THE DRAWINGS

Embodiment may be described in detail with reference to the accompanying drawings, in which:

FIG. 1 is a longitudinal sectional viewot a stepping motor which is shown as an embodiment of the invention;

FIG. 2 is a longitudinal sectional view of a stator yoke element;

FIG. 3 is a perspective view of a stator yoke;

FIG. 4 is a characteristic diagram showing a relationship between rotational torque and rotational speed of motors in which case yoke elements having an outside diameter of 55 mm are used;

FIG. 5 is a characteristic diagram showing a relationship between rotational torque and rotational speed of motors in which case yoke elements having an outside diameter of 49 mm are used;

FIG. 6 is a characteristic diagram showing a relationship between rotational torque and rotational speed of a motor in which a case yoke element having an outside diameter of 42 mm is used and a motor in which a case yoke element having an outside diameter of 49 mm is used;

FIG. 7 is a characteristic diagram showing a relationship between surface temperature of a bracket and driving time of motors in which case yoke elements having an outside-diameter of 49 mm are used;

FIG. 8 is a characteristic diagram showing a relationship between detent torque and rotational angle of the motors in which the case yoke elements having the outside diameter of 49 mm are used; and

FIG. 9 is a characteristic diagram showing a relationship between vibration in a thrust direction and rotational speed of the motors in which the case yoke elements having the outside diameter of 49 mm are used.

### DETAILED DESCRIPTION OF THE INVENTION

The object to realize a stepping motor which is small in size and which can increase the torque and decrease the detent torque while maintaining the low production costs realized is attained by realizing a stepping motor including a rotor element made up of a permanent magnet which is magnetized to a multiplicity of poles, a stator yoke element provided in such a manner as to face the rotor element concentrically and having a plurality of comb tooth-like pole portions, exciting coils mounted on outer circumferential portions of the comb tooth-like pole portions and a case yoke element encompassing the exiting coils and the stator yoke element, wherein the stator yoke element is made of a sheet of silicon steel whose thickness is substantially 0.7 mm.

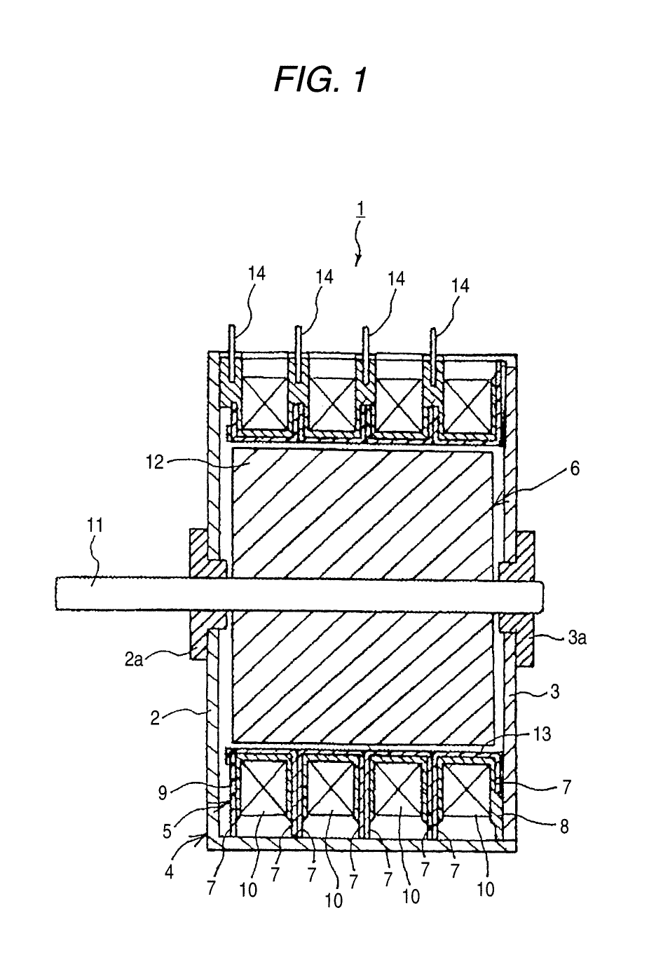

Hereinafter, an embodiment of the invention will be described based on FIG. 1. In FIG. 1, a stepping motor 1 is made up of a case yoke element 4 which is made up, in turn, of a hollow cylindrical case 2 which is opened at one end and a bracket 3 which closes the open end of the case 2, a stator element 5 provided along an inner circumferential surface of the case 2, and a rotor element 6 which is supported rotatably by bearing elements 2a, 3a which are provided on the case and the bracket 3, respectively.

The yoke frame element 4 is made of a metallic material and includes the bearing elements 2a, 3a in the vicinity of centers of end faces thereof.

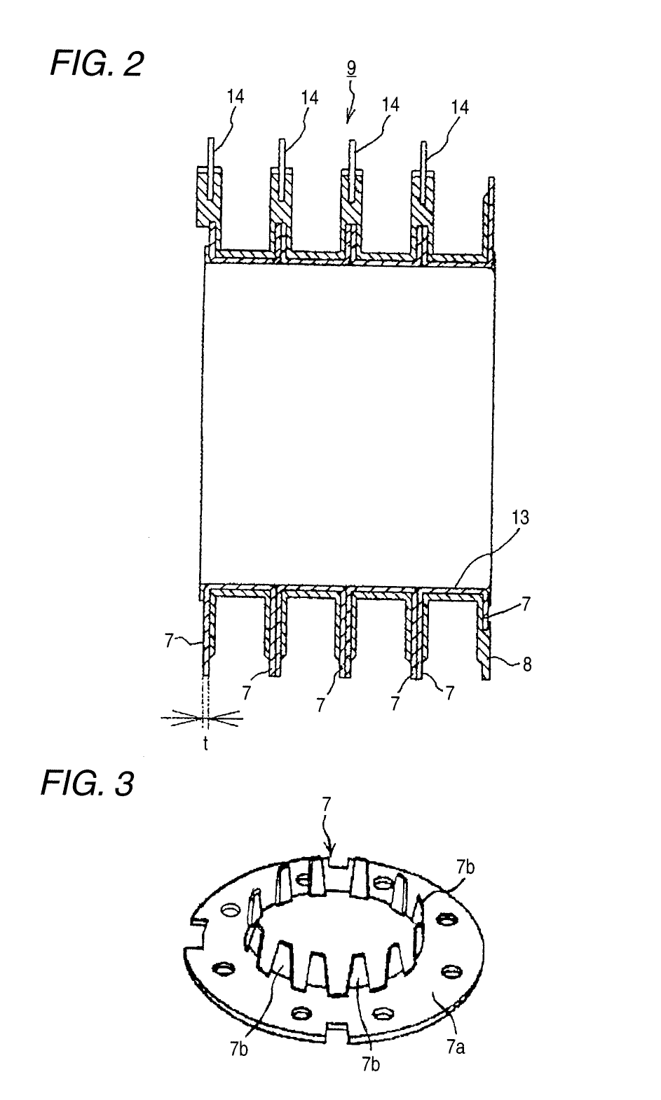

As is also shown in FIG. 2, the stator element 5 is made up of a substantially cylindrical stator yoke element 9 which is made up, in turn, of eight stator yokes 7 which each include a ring-shaped flange portion having an outside diameter which is substantially equal to an inside diameter of the case 2 so as to be able to be accommodated in the case 2 and which are molded together with a resin 8 and exciting coils 10 which are wound round coil winding portions which are defined by the stator yokes 7 of the stator yoke element 9, respectively, and is configured to be accommodated within the case 2 after the exciting coils 10 have been so wound so as to be fixedly held in place.

The rotor element 6 is made up of a rotational shaft 11 which is supported rotatably on the bearing elements 2a, 3a and a hollow cylindrical rotor magnet (a permanent magnet) 12 which is fixed held on to the rotational shaft 11. This rotor magnet 12 is formed so as to have an inside diameter which is made slightly smaller than an inside diameter of a center hole 13 of the stator yoke element 9 and is magnetized to a multiplicity of poles along a circumferential direction.

Here, the stator yokes 7 are each made by pressing a sheet of silicon steel which is substantially 0.7 mm thick. In addition, as is shown in FIG. 3, each stator yoke 7 is made up of the ring-shaped flange portion 7a and magnetic pole teeth 7b, 7b . . . which constitute a plurality of comb tooth-like pole portions which are provided in such a manner as to erect vertically from a circumferential edge portion of the ring-shaped flange portion 7a. In addition, the stator yokes 7 are provided in series in an axial direction thereof with the adjacent flange portions 7a and 7a assembled together back to back, and the stator yokes 7 are molded together with the resin 8, whereby the stator yoke element 9 is built up.

In addition, the exciting coils 10 which are wound round the winding portions of the stator yoke element 9 are connected to terminal pins 14 which are held by the resin 8 at terminal ends thereof by means of soldering or the like.

In addition, the stepping motor 1 which is configured as has been described above can rotate the rotor element 6 in a stepping fashion by virtue of magnetic fields produced in the stator yoke element 9 by causing an electric current to flow to the exciting coils 10 in a predetermined order through the terminal pins 14 and changing the electric current caused to so flow.

In the stepping motor 1 of this embodiment, since the stator yokes 7 are each formed of the sheet of silicon steel which is substantially 0.7 mm thick, a reduction in size an increase in torque can be attained and the detent torque can be decreased without increasing the production costs as a whole, compared to the conventional stepping motor in which the stator yoke element is formed of the sheet of silicone steel which is 0.5 mm thick. This is verified by the results of Experiments which will be described below.

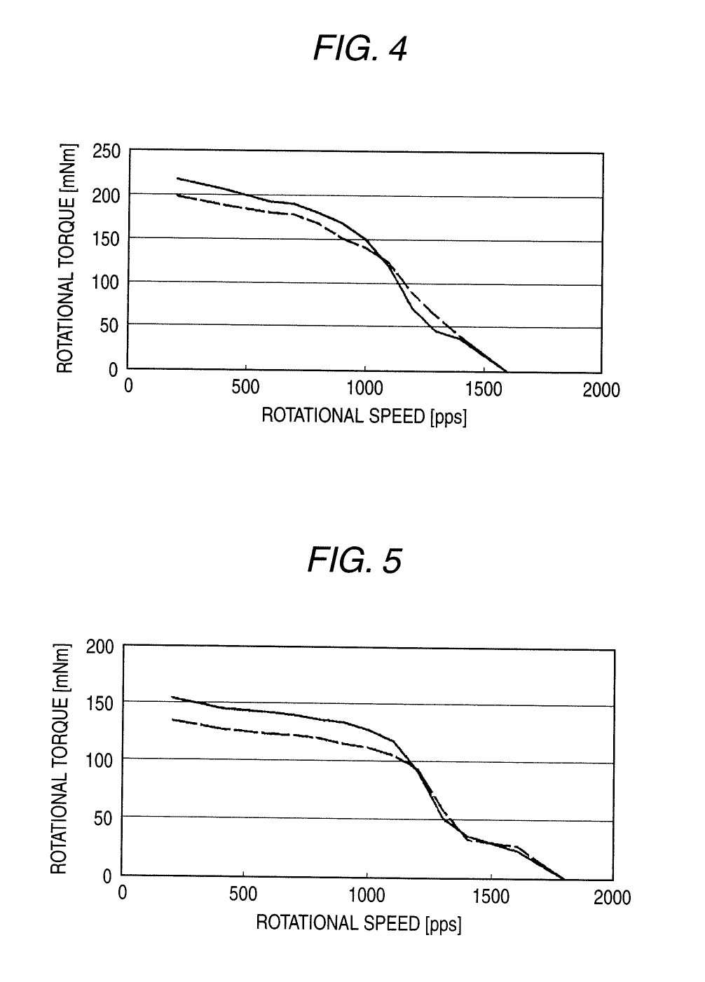

FIG. 4 is a characteristic diagram showing a relationship between rotational torque (mNm) and rotational speed (pps) when a sheet of silicon steel which is 0.7 mm is used for the stator yokes 7. In the diagram, an axis of ordinates denotes rotational torque while an axis of abscissas denotes rotational speed. FIG. 4 shows characteristic curves of a motor according to the invention (indicated by a solid line) in which a sheet of silicon steel which is 0.7 mm thick is used for stator yokes 7 and a conventional motor (indicated by a dotted line) in which a sheet of silicon steel which is 0.5 mm thick is used for stator yokes, with case yoke elements 4 of both the motors made to have an outside diameter of 55 mm.

It is seen from the characteristic diagram shown in FIG. 4 that a higher torque could be obtained on the motor of the invention than on the conventional motor during rotations at low speeds up to substantially 1000 (pps) in the case of the case yoke elements 4 of both the motors having the outside diameter of 55 mm.

FIG. 5 is a characteristic diagram showing a relationship between rotational torque (mNm) and rotational speed (pps) when a sheet of silicon steel which is 0.7 mm is used for the stator yokes 7. In the diagram, an axis of ordinates denotes rotational torque while an axis of abscissas denotes rotational speed. FIG. 5 shows characteristic curves of a motor according to the invention (indicated by a solid line) in which a sheet of silicon steel which is 0.7 mm thick is used for stator yokes 7 and a conventional motor (indicated by a dotted line) in which a sheet of silicon steel which is 0.5 mm thick is used for stator yokes, with case yoke elements 4 of both the motors made to have an outside diameter of 49 mm.

It is seen from the characteristic diagram shown in FIG. 5 that a higher torque could be obtained on the motor of the invention than on the conventional motor during rotations at low speeds until the rotational speed reached substantially 1200 (pps) in the case of the case yoke elements 4 of both the motors having the outside diameter of 49 mm.

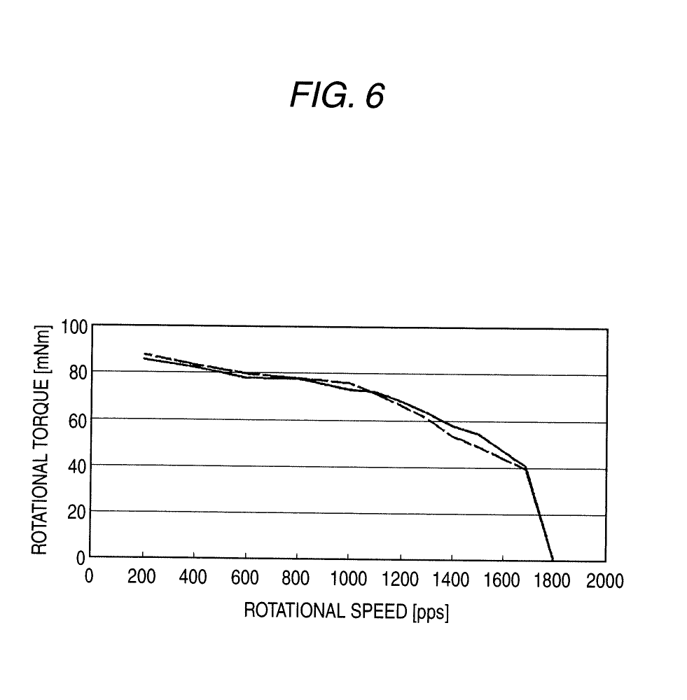

FIG. 6 is a characteristic diagram showing a relationship between rotational torque (mNm) and rotational speed (pps) when a sheet of silicon steel which is 0.7 mm is used for the stator yokes 7. In the diagram, an axis of ordinates denotes rotational torque while an axis of abscissas denotes rotational speed. FIG. 6 shows characteristic curves of a motor according to the invention (indicated by a solid line) in which a sheet of silicon steel which is 0.7 mm thick is used for stator yokes 7 and an outside diameter of a case yoke element 4 is 42 mm and a conventional motor (indicated by a dotted line) in which a sheet of silicon steel which is 0.5 mm thick is used for stator yokes and an outside diameter of a case yoke element 4 is 49 It is seen from the characteristic diagram shown in FIG. 6 that in the event that the sheet of silicon steel which is 0.7 mm thick is used for the stator yokes 7, even though the outside diameter of the case yoke element 4 is 42 mm, a substantially equal torque to a torque obtained on the large conventional motor in which the outside diameter of the case yoke element 4 is 49 mm could be obtained. Consequently, the motor can be obtained which is small in size and which can provide a higher torque.

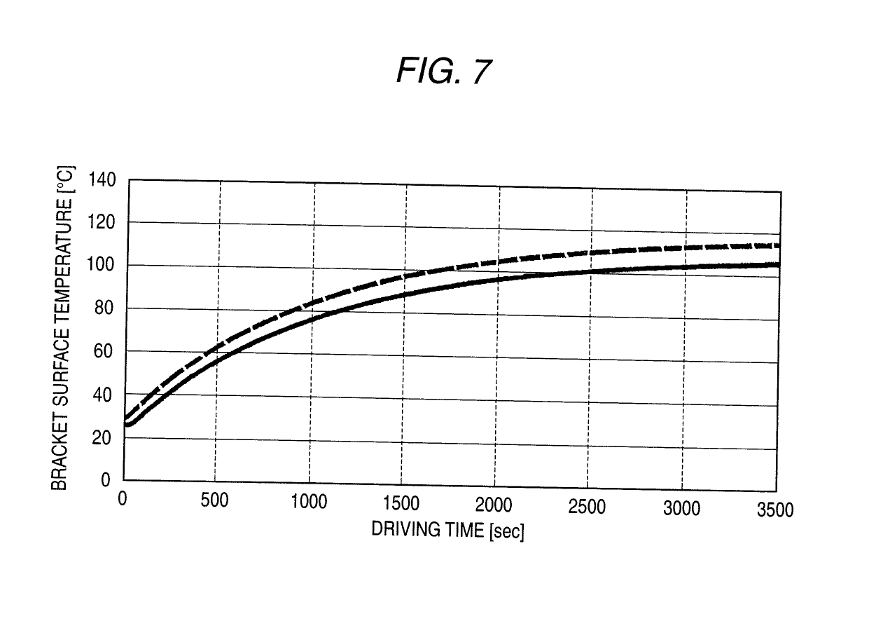

FIG. 7 is a characteristic diagram showing a relationship between surface temperature (° C.) of the bracket 3 and driving time (sec) when a sheet of silicon steel which is 0.7 mm is used for the stator yokes 7. In the diagram, an axis of ordinates denotes surface temperature while an axis of abscissas denotes driving time. FIG. 7 shows characteristic curves of a motor according to the invention (indicated by a solid line) in which a sheet of silicon steel which is 0.7 mm thick is used for stator yokes 7 and a conventional motor (indicated by a dotted line) in which a sheet of silicon steel which is 0.5 mm thick is used for stator yokes, with case yoke elements 4 of both the motors made to have an outside diameter of 49 mm.

It is seen from the characteristic diagram shown in FIG. 7 that the surface temperature (° C.) of the bracket 3 is suppressed to a lower temperature on the motor of the invention than on the conventional motor. Consequently, even though the torque is increased, the surface temperature will not be increased, and hence, even though the motor is run continuously over a long period of time, there will be caused no burning or the like.

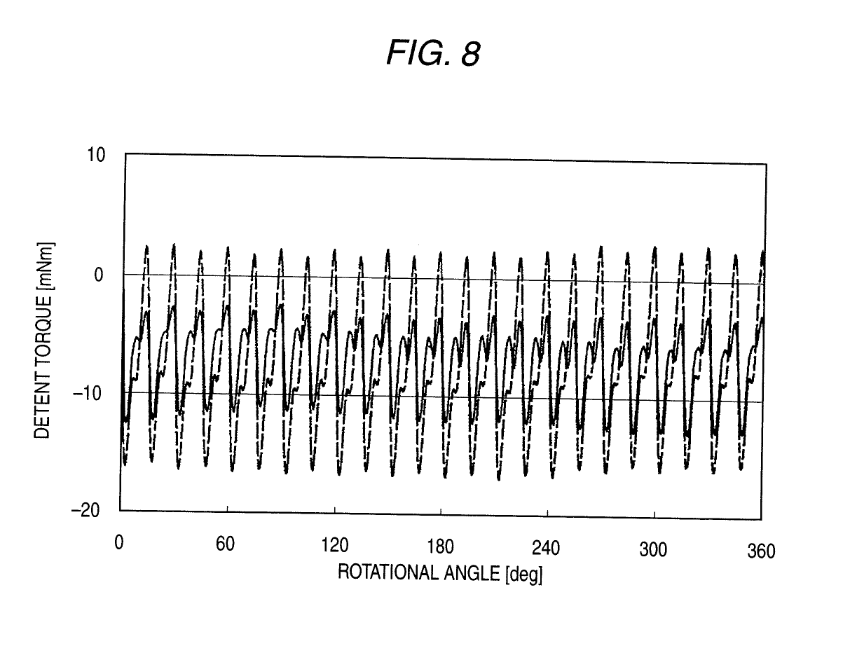

FIG. 8 is a characteristic diagram showing a relationship between detent torque (mNm) and rotational angle (deg) when a sheet of silicon steel which is 0.7 mm is used for the stator yokes 7. In the diagram, an axis of ordinates denotes detent torque while an axis of abscissas denotes rotational angle. FIG. 8 shows characteristic curves of the motor according to the invention (indicated by a solid line) in which a sheet of silicon steel which is 0.7 mm thick is used for stator yokes 7 and the conventional motor (indicated by a dotted line) in which a sheet of silicon steel which is 0.5 mm thick is used for stator yokes, with the case yoke elements 4 of both the motors made to have the outside diameter of 49 mm. Consequently, by attaining a reduction in detent torque, the vibration and noise of the motor are reduced.

It is seen from the characteristic diagram shown in FIG. 8 that the detent torque (mNm) is suppressed to a lower level at all times on the motor of the invention than on the conventional motor in the case of the case yoke elements 4 of both the motors having the outside diameter of 49 mm.

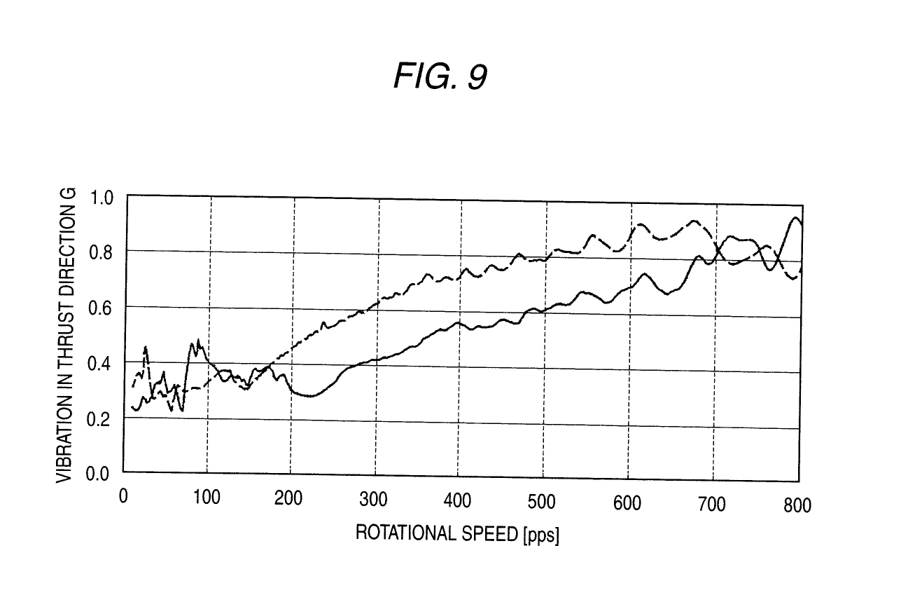

FIG. 9 is a characteristic diagram showing a relationship between vibration (G) in a thrust direction and rotational speed (pps) when a sheet of silicon steel which is 0.7 mm is used for the stator yokes 7. In the diagram, an axis of ordinates denotes vibration in the thrust direction while an axis of abscissas denotes rotational speed. FIG. 9 shows characteristic curves of the motor according to the invention (indicated by a solid line) in which the sheet of silicon steel which is 0.7 mm thick is used for stator yokes 7 and the conventional motor (indicated by a dotted line) in which the sheet of silicon steel which is 0.5 mm thick is used for the stator yokes, with the case yoke elements 4 of both the motors made to have the outside diameter of 49 mm.

It is seen from the characteristic diagram shown in FIG. 9 that the vibration (G) in the thrust direction is suppressed to a lower level on the motor of the invention as a whole than on the conventional motor in the case of the case yoke elements 4 of both the motors having the outside diameter of 49 mm.

Besides, in the above examples, eight stator yokes are used as shown in FIG. 2. However, this invention is not limited to the above examples. For example, this invention can be applied to a situation that a number of stator yokes is less than eight. In this situation, it is capable of further reduction in size of a motor about an axial direction of a rotational shaft.

Further, the invention can be modified variously without departing from the concept and scope thereof, and needless to say, the invention includes those modified examples.

What is claimed is:

1. A stepping motor comprising:
a cylindrical rotor rotable about a rotary axis, the rotor being magnetized so as to have a plurality of poles along a circumferential direction thereof;
stator yokes each of which has a plurality of pole portions facing an outer circumferential face of the rotor;
an exciting coil wound on the pole portions; and
a case yoke accommodating the exciting coil and the stator yokes,
wherein each of the stator yokes is made of a sheet of silicon steel having a thickness of 0.7 mm.

2. The stepping motor according to claim 1
wherein the pole portions are annularly arranged with intervals.

3. The stepping motor according to claim 1
wherein an outer diameter of the case yoke falls within a range from 42 mm to 55 mm.
